(19) United States
(12) Patent Application Publication
(10) Pub. No.: US 2006/0191890 A1
(43) Pub. Date: Aug. 31, 2006

(54) Temperature indicating soldering assembly

(76) Inventors: Michael L. Agronin, Owings Mills, MD (US); Scott Kolodziejski, Joppa, MD (US); Paul A. Stephenson, Owings Mills, MD (US); Joe Rogers, Jarrettsville, MD (US); Christopher J. Murray, Baltimore, MD (US)

Correspondence Address: HARNESS, DICKEY & PIERCE, P.L.C., P.O. BOX 828, BLOOMFIELD HILLS, MI, 48303, US

(21) Appl. No.: 11/297,814

(22) Filed: Dec. 8, 2005

Related U.S. Application Data
(60) Provisional application No. 60/637,341, filed on Dec. 17, 2004.

(51) Int. Cl. H05B 3/42; H05B 1/00

(52) U.S. Cl. 219/241

(57) ABSTRACT

A soldering assembly has a base with a support member and at least one workpiece support member to support a workpiece. A soldering iron is removably supported by the base support member. The soldering iron includes a heating element and a heatable tip heated by the heating element. The soldering iron also has a temperature indicator that is movable, between positions, depending on the temperature of the heatable tip. Thus, the soldering iron indicates the temperature of the heatable tip to a user.

### CROSS REFERENCE TO RELATED APPLICATION

This application claims the benefit of U.S. Provisional Application No. 60/637,341, filed Dec. 17, 2004.

### FIELD OF THE DISCLOSURE

The present invention relates to soldering assemblies and, more particularly, to a temperature indicating soldering assembly.

### BACKGROUND OF THE DISCLOSURE

It is known to use a crafting iron or soldering iron for numerous crafts, such as wood burning, soldering, cutting of plastic, bonding objects with hot melt glue, transferring printed patterns on paper onto another surface, or embossing a pattern into a fabric. These crafting irons or soldering irons are readily available and are generally provided with numerous tips which can be interchanged to accomplish the desired task. However, these crafting or soldering irons, ordinarily have only a single temperature setting. This single temperature setting may not be suitable for all uses. For instance, if the tip is set to a temperature hot enough to burn wood, the tip may be too hot to transfer a printed pattern from paper onto another surface or emboss fabric. Likewise, if the iron is set to a lower temperature for embossing fabric, the iron will likely not be hot enough to burn wood.

Also, the user is normally unaware of the temperature of the heating element. Thus, the user may not know when the tip is hot enough for use or whether the tip is cool enough to touch.

In addition, when using the soldering iron, it can be difficult to hold the workpiece and the soldering iron at the same time. The workpiece can be set on a workbench, but this may not be suitable for certain jobs. The workpiece can also be secured in a vice or other similar holding apparatus. However, this may not be convenient.

Thus, a need remains for a soldering iron that can be adjusted to a plurality of temperature settings. There also remains a need for a soldering iron that can indicate the temperature of the soldering iron to the user. Furthermore, there remains a need for a soldering assembly with a more convenient means of securing a workpiece. These features would be desirable in a soldering assembly while maintaining the low cost of the product.

### SUMMARY OF THE DISCLOSURE

According to the present invention, a soldering iron is provided which includes a housing and a heating element. The soldering iron also includes a heatable tip that can be heated by the heating element and that extends from the housing. The soldering iron further includes a temperature indicator that is movable between positions depending on the temperature of the heatable tip. Thus, the soldering iron indicates the temperature of the heatable tip to the user.

In another aspect, the present invention is a base that supports the soldering iron. The base includes a support member adapted to support the soldering iron. The base also includes at least one workpiece support member adapted to support a workpiece.

In still another aspect, the present invention provides a soldering iron that includes a housing, a heating element, and a heatable tip. The heatable tip can be heated by the heating element and extends from the housing. The soldering iron also includes a half-wave rectification circuit operable to variably heat the heatable tip to a low temperature setting and a high temperature setting via half-wave rectification.

In a further aspect, the present invention is a soldering assembly that includes a base with a support member and at least one workpiece support member adapted to support a workpiece. The soldering assembly also includes a soldering iron adapted to be removably supported by the support member of the base. The soldering iron includes a heating element, a heatable tip that can be heated by the heating element, and a temperature indicator. The temperature indicator is movable between positions depending upon the temperature of the heatable tip. Thus, the soldering iron indicates the temperature of the heatable tip to a user.

From the following detailed description in conjunction with the accompanying drawings, other objects and advantages of the present teaching will become apparent to those skilled in the art.

### BRIEF DESCRIPTION OF THE DRAWINGS

The present invention will become more fully understood from the detailed description and the accompanying drawings, wherein:

FIG. 1 is a perspective view of a soldering assembly with a soldering iron positioned in a base in accordance with the present invention;

FIG. 2 is an elevation view of a soldering iron in accordance with the present invention;

FIG. 3 is an elevation view with a portion of the housing removed from the soldering iron of FIG. 2;

FIG. 3A is a perspective view of FIG. 3 of the heating element;

FIGS. 4-6 are elevation views of the soldering iron with the temperature indicator in various positions;

FIG. 7 is a circuit diagram of the soldering iron; and

FIG. 8 is a perspective view of the soldering assembly base in accordance with the present invention.

### DETAILED DESCRIPTION OF THE PREFERRED EMBODIMENTS

The following description of the preferred embodiment(s) is merely exemplary in nature and is in no way intended to limit the disclosure, its application, or uses.

Turning to the figures, a soldering assembly is generally indicated at 13. The soldering assembly 13 includes a craft or soldering iron, generally indicated at 10 and a base, generally indicated at 12. The base 12 includes a support member 14 to support the soldering iron 10 when it is not in use.

The soldering iron 10 includes a housing 18 with a heating element 20 and a power cord 22, which is adapted to plug into an AC outlet. The heating element 20 includes a heatable tip 23 at one end. The housing 18 is of a clam shell design and substantially encapsulates the heating element 20. The heatable tip 23 extends out from inside the housing 18. When power is supplied to the heating element 20 it becomes heated, which, in turn, heats the tip 23. Once the tip 23 is sufficiently hot, the tip 23 can be used for soldering, embossing, burning wood, bonding, and the like. In one embodiment, the tip 23 is removably attached to the heating element 20 such that the tip 23 can be replaced, depending on the intended use of the soldering iron 10.

The soldering iron 10 also includes a temperature indicator 26 that is movable between positions depending on the temperature of the heatable tip 23. This indicates the temperature of the heatable tip 23 to the user. More specifically, the temperature indicator 26 is made from a plurality of materials, and at least two of the materials have different coefficients of thermal expansion. For instance, the temperature indicator 26 includes a bi-metal or thermostat metal coil strip 30 made from two strips of metal bonded or otherwise secured together. Each strip is of a different alloy with a different co-efficient of thermal expansion. In one embodiment, the temperature indicator 20 is a B1 bi-metal material that is 0.007 inches thick and 5 inches long. In another embodiment, a strip of one material is coated with another material having a different coefficient of thermal expansion. The temperature indicator 26 is at least partially coiled about the heating element 20 as shown in FIG. 3a. The temperature indicator 26 is coupled at one end to the heating element 20 by, for example, welding, soldering, rivets, bonding or the like. The temperature indicator 26 is coiled around the heating element 20 such that the temperature indicator 26 receives heat from the heating element 20. Also, the housing 18 includes a window 24 that enables viewing of a portion of the temperature indicator 26.

When the heating element 20 is heated, the heat transfers to the temperature indicator 26 which moves accordingly. More specifically, the temperature indicator 26 coils tighter or uncoils looser depending on how the strip 30 is wound. If the temperature indicator 26 is wound with the higher thermal coefficient material on the outside of the coil then the heat causes it to wind tighter. If the temperature indicator 26 is wound with the higher thermal coefficient material on the inside of the coil then the heating causes the temperature indicator 26 to uncoil. When the heating element 20 cools, the strip 30 also cools and moves in the opposite manner. In another embodiment, the temperature indicator 26 is axially straight when cool, but as the temperature indicator 26 heats up, the temperature indicator 26 bends and partially coils. Thus, by coiling and uncoiling, the temperature indicator 26 indicates the temperature of the heatable tip 23 to the user.

It should be appreciated that a thinner bi-metal material of the temperature indicator 26 bends more over a given temperature range than a thicker bi-metal material. It should also be appreciated that a longer coil will typically bend more than shorter coil.

The heating element 20 is adjustable to heat the heatable tip 23 to a plurality of discrete temperature settings. For instance, the heating element 20 can be adjusted to a high temperature setting and a low temperature setting. FIG. 7 includes an illustration of a half-wave rectification circuit for adjusting the temperature of the heating element 20. The soldering iron 10 includes a switch 28 to control the temperature setting of the heating element 20. The switch 28 may be a two or three position switch. The switch 28, in a first position, would enable the heating element 20 to heat to the low temperature setting, for example, between approximately 400° F. and 500° F., for many craft activities such as pattern transfer or fabric embossing. In a second position, the switch 28 enables the heating element 20 to heat to the high temperature setting, for example, between approximately 700° F. and 900° F., for activities such as wood burning or soldering. The switch 28 is connected to the heating element 20 to provide either full power (second position) or half-wave rectified power via a diode 38. The switch 28 can have a third, totally off, position. Thus, the heating element 20 is adjustable to a plurality of temperatures so that the soldering iron 10 can be used for higher temperature and lower temperature applications. Also, the switch 28 and diode 38 provide a relatively inexpensive means of providing different temperature levels.

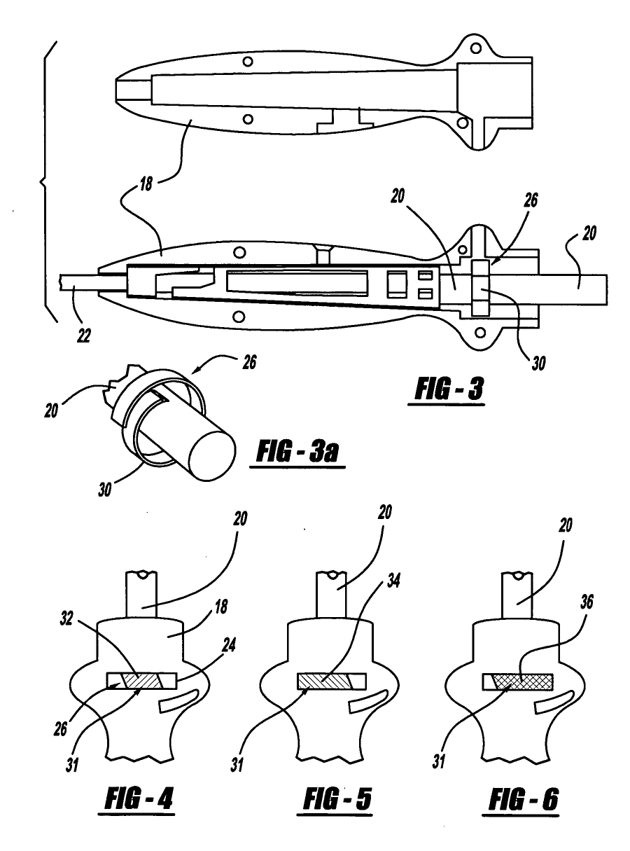

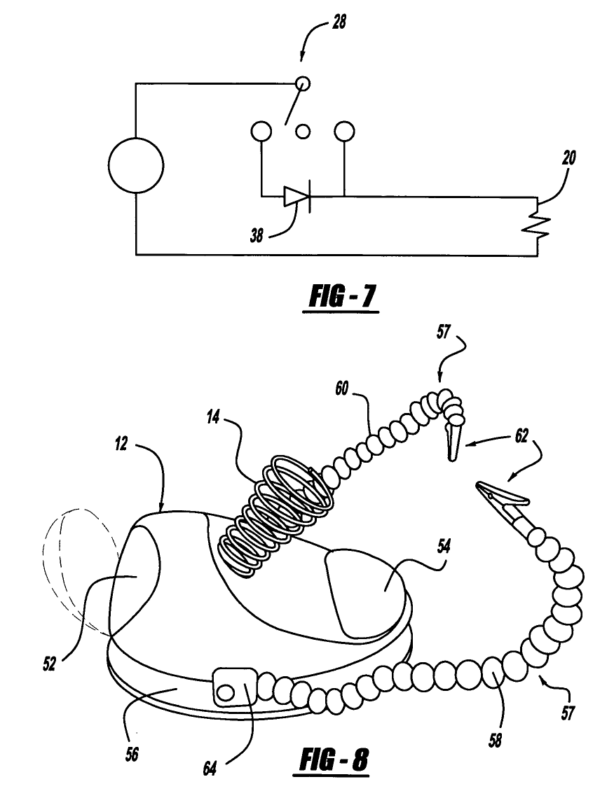

The temperature indicator 26 also includes at least one visual indicator, generally indicated at 31 in FIGS. 4-6. The visual indicator 31 is adapted to visually indicate the temperature of the heatable tip 23 to the user. The visual indicator 31 is coupled to the temperature indicator 26 and can visibly distinguish between a plurality of temperatures of the heatable tip 23. For instance, in the embodiment shown in FIGS. 4-6, the visual indicator 31 includes a plurality of portions that differ by color or indicia to indicate the different temperatures of the heatable tip 23. More specifically, when the soldering iron 10 is cool, a blue portion 32 of the visual indicator 31 shows through the window 24 as shown in FIG. 4. Then, when the switch 28 is in the first position, the heating element 20 heats up, and the temperature indicator 26 moves by coiling or uncoiling. When the heatable tip 23 reaches the first temperature setting, an orange portion 34 of the visual indicator 31 is revealed through the window 24 to indicate to the user that the heatable tip 23 has reached the first temperature setting. Then, when the switch 28 is in the second position, the heating element 20 heats up further, and the temperature indicator 26 moves by coiling or uncoiling. When the heatable tip 23 reaches the second temperature setting, a red portion 36 of the visual indicator 31 is revealed through the window 24 to indicate to the user that the heatable tip 23 has reached the second temperature setting. Thus, the user can be informed of the present temperature of the heatable tip 23. It should be appreciated that the visual indicator 31 could be adapted to indicate a range of temperatures of the heatable tip 23 without departing from the scope of the present disclosure. For instance the portions 32, 34, 36 of the visual indicator 31 can be of a sufficient width such that a single portion 32, 34, 36 is visible through the window 24 while the heatable tip 23 is between a predetermined temperature range.

It should be appreciated that the visual indicator 31 could be of any suitable type. For instance, in an alternate embodiment, the visual indicator 31 includes a temperature scale disposed on the housing 18 and a marker disposed on the temperature indicator 26. Thus, as the temperature indicator 26 moves, the marker moves relative to the scale to indicate the temperature of the heatable tip 23. The visual indicator 31 could also include numbers, words such as “Hot” and “Cold”, or other representative symbols. The visual indicator 31 can include elements on one of or both of the housing 18 and the temperature indicator 26.

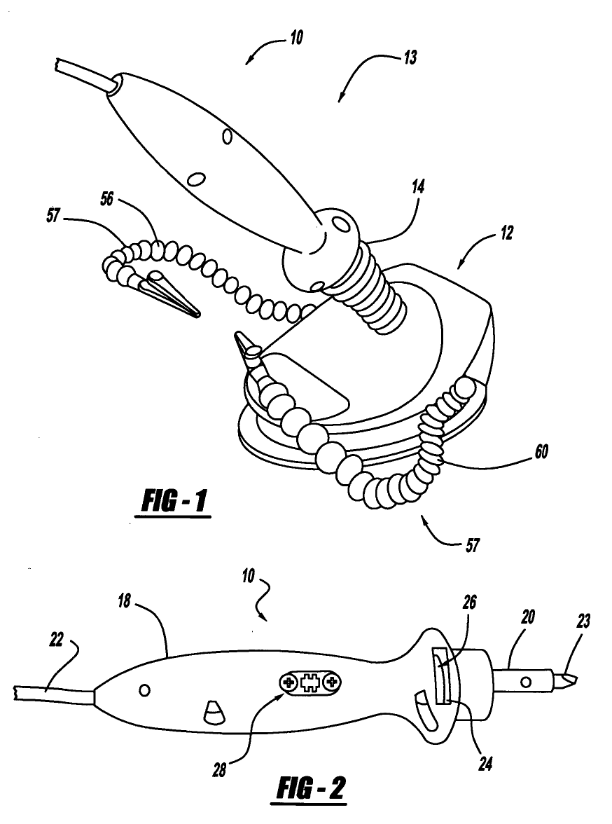

Turning now to FIGS. 1 and 8, the soldering base 12 is illustrated. In one embodiment, the support member 14 is a helical member, such as a metal helical coil. The support member 14 could also be a tube made out of screen, perforated metal, formed wires, or the like. The support member 14 supports the soldering iron 10 without contacting the heating element 20 and allows air to pass for cooling the heating element 20 and heatable tip 23. Also, the base 12 includes a storage compartment or drawer 52 which may be utilized to store different types of soldering tips. The storage compartment 52 could be pivotally attached, or the storage compartment 52 could be removably attached. The storage compartment 52 could also be a pocket in the base 12 that has no door. Alternatively, the storage compartment 52 could be a pocket with a hingeably attached door. The base 12 also includes a cleaning device 54, such as a sponge, a piece of grit paper, a piece of metal (steel, aluminum, copper) wool, or other similar material to clean the iron tip. Further, the base 12 may include a circumferential groove 56 for receiving a power cord and to enable wrapping of a power cord of the soldering iron 10 around the base 12 for more compact storage of the soldering assembly 13.

The base 12 also includes a workpiece support member, generally indicated at 57 adapted to support a workpiece (not shown). In the embodiment shown, the workpiece support member 57 includes a pair of flexible arms 58, 60. The arms 58, 60 are each coupled to the base 12 at one end and include a clamping member 62, such as an alligator clip, at the opposite end to hold the workpiece. The arms 58, 60 each comprise a plurality of ball and socket elements. Friction between the socket elements and the ball elements allows the arms 58, 60 to be held in a bent position. Thus, the arms 58, 60 can hold the workpiece in a position desired by the user for added convenience.

It should be appreciated that the clamping members 62 can be of any suitable type such as clamps and interchangeable clamps such as three jaw chucks or screw type vice clamps. Also, an illumination device may be secured to the base 12 to provide illumination on the workpiece. Further, the base 12 could include any number of workpiece support members 57 without departing from the scope of the invention. Also, the arms 58, 60 could be of different sizes and configuration. Also, a different type of workpiece support member 57 other than the arms 58, 60 may be included to support the workpiece.

The description of the disclosure is merely exemplary in nature and, thus, variations that do not depart from the gist of the disclosure are intended to be within the scope of the invention. Such variations are not to be regarded as a departure from the spirit and scope of the disclosure.

What is claimed is:

1. A soldering iron comprising:
a housing;
a heating element;
a heatable tip that can be heated by the heating element, the tip extending from the housing; and
a temperature indicator that is movable between positions depending on the temperature of the heatable tip, thereby indicating temperature of the heatable tip to a user.

2. The soldering iron of claim 1, wherein the temperature indicator is at least partially coiled, and wherein the temperature indicator moves between positions by coiling and uncoiling.

3. The soldering iron of claim 2, wherein the temperature indicator is at least partially coiled about the heating element.

4. The soldering iron of claim 1, wherein the temperature indicator is made from a plurality of materials, and wherein at least two of the plurality of materials have different coefficients of thermal expansion to provide temperature-dependent movement of the temperature indicator.

5. The soldering iron of claim 1, wherein the temperature indicator is coupled to the heating element.

6. The soldering iron of claim 1, wherein the housing at least partially encapsulates the temperature indicator, the housing including a window adapted to reveal the temperature indicator to the user.

7. The soldering iron of claim 1, further comprising at least one visual indicator to indicate the temperature of the heatable tip to the user.

8. The soldering iron of claim 7, wherein the visual indicator is adapted to visibly distinguish between a plurality of temperatures of the heatable tip.

9. The soldering iron of claim 8, wherein the visual indicator includes a plurality of portions that differ by color to distinguish between a plurality of temperatures of the heatable tip.

10. The soldering iron of claim 1, wherein the heating element is adjustable to heat the heatable tip to a plurality of temperature settings.

11. A base for supporting a soldering iron comprising:
a support member adapted to support the soldering iron; and
at least one workpiece support member adapted to support a workpiece;

12. The base of claim 11, wherein the workpiece support member comprises at least one flexible arm and a clamping member at one end of the flexible arm.

13. The base of claim 12, wherein the flexible arm comprises a plurality of ball and socket elements such that the flexible arm can be bent and can be positioned in a plurality of positions.

14. The base of claim 11, wherein the support member allows air to pass to the soldering iron.

15. The base of claim 14, wherein the support member is a helical member.

16. The base of claim 11 further comprising at least one of a storage compartment, a cleaning device adapted to clean a tip of the soldering iron, and a groove for receiving a power cord.

17. A soldering iron comprising:
a housing;
a heating element;
a heatable tip that can be heated by the heating element and that extends from the housing; and
a half-wave rectification circuit operable to variably heat the heatable tip to a low temperature setting and a high temperature setting via half-wave rectification.

18. The soldering iron of claim 17, further comprising a temperature indicator that is movable between positions depending on the temperature of the heatable tip, the temperature indicator including at least one visual indicator adapted to visibly distinguish between a plurality of temperatures of the heatable tip, thereby indicating temperature of the heatable tip to a user.

19. A soldering assembly comprising:
a base with a support member and at least one workpiece support member adapted to support a workpiece; and
a soldering iron adapted to be removably supported by the support member of the base, and comprising a heating element, a heatable tip that can be heated by the heating element, and a temperature indicator that is movable between positions depending on the temperature of the heatable tip, thereby indicating temperature of the heatable tip to a user.

19. The soldering assembly of claim 19, wherein the heating element is adjustable to heat the heatable tip to a plurality of discrete temperature settings.

20. The soldering iron of claim 19, further comprising a half-wave rectification circuit that varies the temperature of the heating element via half-wave rectification, and wherein the heating element has a low temperature setting and a high temperature setting.
